(19) United States
(12) Patent Application Publication
(10) Pub. No.: US 2019/0391321 A1
(43) Pub. Date: Dec. 26, 2019

(54) LIGHTING DEVICE AND METHOD FOR MANUFACTURING SAID LIGHTING DEVICE

(71) Applicant: Ficomirrors, S.A.U., Barcelona (ES)

(72) Inventors: Nestor Ruiz Ortega, Barcelona (ES); Gonzalez Madorran Til, Barcelona (ES)

(21) Appl. No.: 16/451,769

(22) Filed: Jun. 25, 2019

(30) Foreign Application Priority Data
Jun. 26, 2018 (EP) 18382475.4

(51) Int. Cl. F21V 8/00; G02B 6/36

(52) U.S. Cl. CPC G02B 6/0065; G02B 6/0055; F21K 9/237; G02B 6/3668; G02B 6/0073

(57) ABSTRACT

The lighting device comprises a light guide comprising two or more layers; and a light source that illuminates the light guide. The two or more layers define at least one surface between two adjacent layers. Geometric motives are formed in the at least one surface. The method for manufacturing the lighting device includes the step of providing one layer. Geometric motives are then formed in the one layer. After this formation, another layer is injected directly to the geometric motives, thus defining a surface between the layers that provides a better homogenous illuminance and a better photometric performance.

### CROSS-REFERENCES TO RELATED APPLICATIONS

This patent application claims priority to European Provisional Patent Application No. 18382475.4, filed Jun. 26, 2018, which is incorporated herein by reference in its entirety.

### INTRODUCTION

The present disclosure relates to a lighting device, and more particularly, a vehicle lighting device that provides different optical styles or functional effects, and a method of manufacture.

Lighting devices for vehicle lighting units comprising light guides are known in the art. Lighting devices comprising such light guides enhance the vehicle from an aesthetic point of view while fulfilling safety functions.

In these light guides the geometric motives used for optical or style reasons usually are only located in the external area of the light guide, usually in the back side.

This kind of lighting devices may have some drawbacks, such as:
The depth of the geometric motives is limited because if it increases the light guide thickness is also increased and the possibility of being able to leave internal defects also increase, decreasing the photometric efficiency with a reduced visual style appearance;
The style appearance is worse because there is less flexibility in the geometric shapes (limited height or depth of the geometric motives), so that a more uniform shape is needed;
More difficult to reach photometric values required by regulations due to light losses during light conduction through the light guide, so that a greater number of light sources or light sources with more intensity could be necessary; and
No possibility of creating 3D visual effects.

An example of a lighting device comprising a light guide is disclosed in U.S. Pat. No. 9,879,840, dated Jan. 30, 2018, and is incorporated herein by reference in its entirety. This patent discloses a motor vehicle lamp comprising a light conducting element formed by upper and lower light coupling parts and an optically active surface embedded between both coupling parts

The optically active band shape is made of a flat material embedded with its longitudinal extension direction along the direction of the light and it is completely surrounded by the upper and lower light conducting bodies and the flat material embedded has to have a different refraction index from of the light conductive element.

In such an optic part, light interacts with the flat material due to the different of refraction index, which can be seen by the naked eye.

However, this light guide presents the following problems:
The need to add a flat material with the geometric motives, further the light guide;
The flat material has a different refraction index from the light guide, therefore the need to use a different material; and
The sections between layers with different direction than the light inside the light guide, are most transmitting efficient, and flat sections are not the most transmitting efficient shape.
   Therefore, providing a lighting device comprising geometric motives providing better homogenous illuminance and a better photometric performance is desirable.

### SUMMARY

The lighting device according to the present disclosure comprises a light guide comprising two or more layers; and a light source that illuminates the light guide, characterized in that the two or more layers define at least one surface between two adjacent layers, geometric motives being formed in the at least one surface.

Advantageously, the geometric motives are geometric shapes formed in the at least one surface, and according to a preferred embodiment the geometric motives are recesses and protrusions made in the at least one surface.

Preferably, the geometric motives have a depth or height from 0.4 mm to 15 mm, such as between 0.8 and 12 mm, and optimally between 1 and 10 mm.

The two or more layers are applied individually by injection, injecting one over the other.

The injecting parts can be of the same or different materials but at least one of the parts must be transparent or semi-transparent (milky, smoked, etc). If the materials are different, further visual effects due to the different refraction and reflective properties are possible. Examples of materials suitable for the lighting device are polymethyl methacrylate (PMMA), polycarbonate (PC) and polyamide (PA) for at least one of the injection phases and for the other injection phase has to be the same material or a material which could be combinable with the first material phase.

Preferably, the two or more layers are transparent, or they can be colored with any suitable color.

For example, the geometric motives can be made by engraving or graining after the injection of the first layer or during the own injection process itself of that first layer, or by any suitable method in that first layer. The second layer is injected directly over the geometric motives made on the first layer.

According to a possible embodiment, the light guide can be covered by an external lens, and the light guide and the light source can be housed in a housing.

In the present disclosure, as the motives are created with protrusions and these motives have directions different to the direction of the light inside the light guide, the efficiency of light transmission is enhanced.

On the other hand, in a system with a layer injected perfectly over another injected layer with the same material, same refractive indexes, the second injection does not leave any air bubble between injected labels so there is no change in the refractive index between materials and no motive is be seen. For that reason, it is necessary to obtain imperfections between both injections through a texturization of the surface of the motive, so that the second material cannot perfectly copy its roughness and thus have some air bubbles between both surfaces. The air bubbles acts as a second material with different refractive index.

The creation of that texturization could be also used with layers of different refraction index. The texturization enhances the lighting effect of the light guide.

The range of textures in the surface of the motive should be greater than 5 μm and optimally greater than 10 μm, since in this way the roughness is not copied by the other injection, and in the largest case, we have a maximum range of less than 400 μm, a maximum range of less than 300 μm and an optimum range of less than 200 μm.

A possible optimization of the embodiment is forming in one external layer, geometric motives that will not be over-injected by another layer, thus, optimizing the quantity of material used to manufacture the light guide.

According to a second aspect, the present disclosure also refers to a method for manufacturing a lighting device as described previously, the method comprising the following steps:
providing one layer;
forming geometric motives in at least one surface of one layer; and
providing another layer injected directly to the geometric motives formed in the one layer defining a surface between the layers.

The method can also comprise forming second geometric motives in the other layer than the surface between the layers of another layer, an additional layer injected directly to the second geometric motives and defining an additional surface between the additional layer and one of the other two layers.

Furthermore, the step of providing one layer and forming the geometric motives can be carried out during the injecting step.

Preferably, the layers are provided by injection, and the geometric motives are formed during the same injection or by engraving or graining.

The lighting device of the present disclosure provides at least the following advantages:
Better homogenous illuminance;
Better photometric performance;
The creation of one light conductive element, without the necessity to add an embedded material;
More flexibility in geometrical shapes and optic effects;
High depth of geometric motives are allowed, so that a 3D visual effect is obtained; and
More quantity of motives is allowed and diversity concerning the type is obtained (complicated shapes, graining treatments, etc.).

The above features and advantages, and other features and advantages of the disclosure are readily apparent from the following detailed description when taken in connection with the accompanying drawings.

### BRIEF DESCRIPTION OF THE DRAWINGS

For a better understanding the above explanation and for the sole purpose of providing an example, some non-limiting drawings are included that schematically depict a practical embodiment.

Other features, advantages and details appear, by way of example only, in the following detailed description, the detailed description referring to the drawings in which:

FIG. 1 is a cross-section view of the lighting device of the present invention, according to a first embodiment;

FIG. 2 is a cross-section view of the lighting device of the present invention, according to a second embodiment;

FIG. 3 is a frontal view of a geometric motive within the lighting device of the present invention, according to an example;

FIG. 4, is a section view along line IV-IV shown in FIG. 3;

FIG. 5 is a cross-section view where the first injection phase of the first layer of the lighting device of the present invention is shown;

FIG. 6 is a cross-section view where the second injection phase of the second layer of the lighting device of the present invention is shown; and

FIG. 7 is a cross-section of an example of the lighting device of the present invention, where both layers have geometric motives.

### DETAILED DESCRIPTION

The present disclosure relates to a lighting device, generally identified by reference numeral 1, comprising a light guide 2 and a light source 3, wherein the light source 3 illuminates the light guide 2. Both the light guide 2 and the light source 3 can be housed in a housing 4 and an external lens 5 can cover the light guide 2.

The light source 3 can be any suitable light source, such a LED or combination of LEDs, or the like.

The lighting device 1 according to the present disclosure is especially designed to be used in a vehicle. However, it is evident that it can be used in other applications.

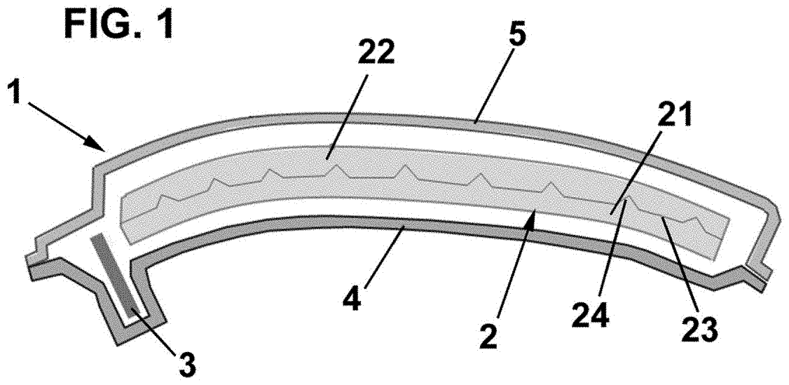

According to a first embodiment, shown in FIG. 1, the light guide 2 is formed by two layers 21, 22 defining between them a surface 23, i.e. the common surface in contact between both layers 21, 22.

A plurality of geometric motives 24 are formed in the surface 23 for providing an optical effect when the light source 3 emits light and illuminates the light guide 2.

The geometric motives 24 are geometric shapes (such as stripes or any suitable shape) formed in the surface 23. For example, and as shown in FIG. 1, the geometric motives 24 are recesses and protrusions made in the surface 23.

Just as an example, the geometric motives 24 have a depth or height from 0.4 mm to 15 mm.

These geometric motives 24 can be made to the first layer, for example, during the same injection process or by engraving or graining, or by any suitable method, defining any texture or effect.

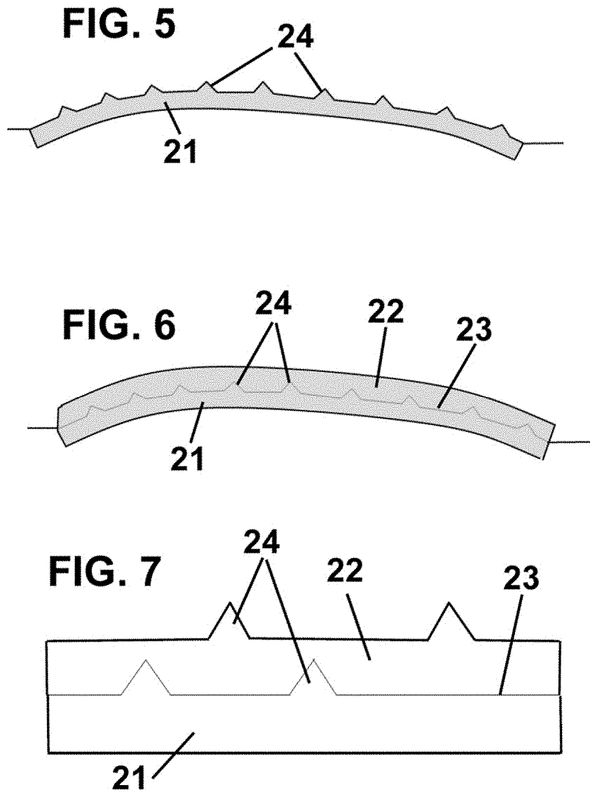

The light guide 2 is made by injection. For example, first injecting the first layer 21 with the geometric motives 24 (FIG. 5) and then the geometric motives in the first layer 21 are filled with the second layer 22, which is also injected (FIG. 6).

The light guide 2 is preferably transparent or colored with any suitable color, and it is usually made from any suitable plastic material. Each layer 21, 22 could be made with the same material or with different material.

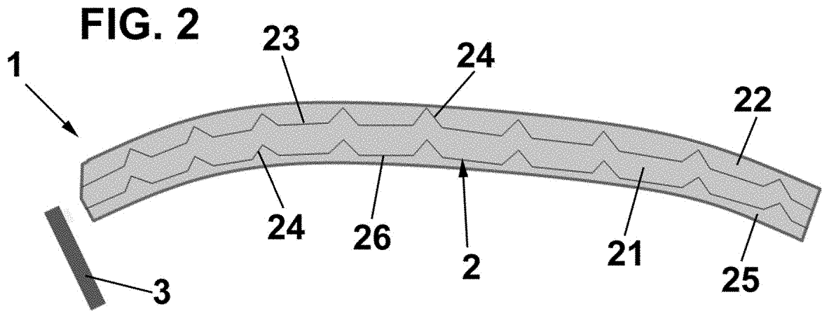

FIG. 2 shows a second embodiment of the lighting device according to the present disclosure. For simplicity reason the same elements from the first embodiment are identified by the same numeral references and they are not further described.

The main difference in this second embodiment with respect the first embodiment is that the light guide 2 is made from three layers 21, 22, 25, defining two surfaces 23, 26 between two adjacent layers 21, 22 and 22, 25, respectively.

In this embodiment, the geometric motives 24 are formed in both surfaces 23, 26.

However, it must be pointed out that the geometric motives 24 could be formed only in one of the surfaces 23, 26.

In this case, the layers 21, 22, 25 are also sequentially injected, as described previously with respect to the first embodiment.

With the lighting device according to the present disclosure a 3D optical effect can be obtained by the geometric motives 24 formed directly in the surface(s) 23, 26 in contact between adjacent layers 21, 22, 25.

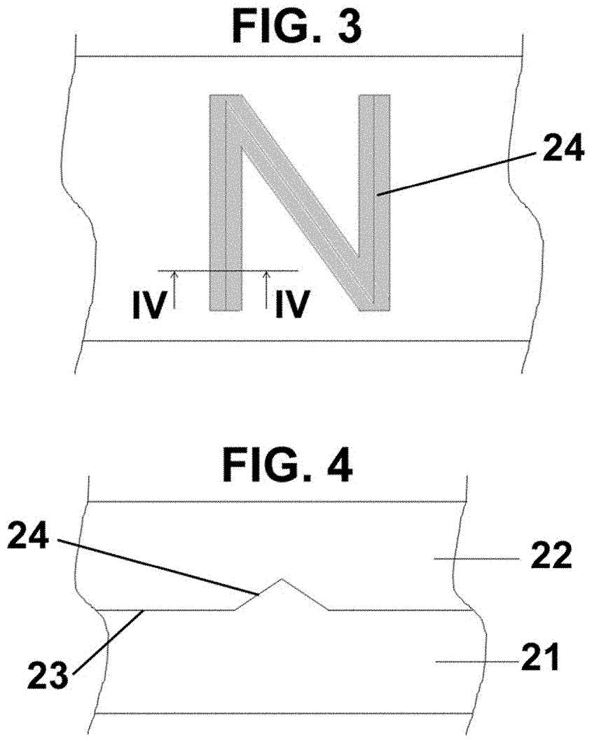

In FIGS. 3 and 4 an example of the lighting device according to the present disclosure is shown. According to this example, the geometric motives 24 form a letter “N”. In this example, the letter “N” has a height of 2 mm and a thickness of 6 mm.

Finally, FIG. 7 is a cross-section of another example of the lighting device of the present disclosure, where both layers have geometric motives.

Even though reference has been made to a specific embodiment of the disclosure, it is obvious for a person skilled in the art that the lighting device described herein is susceptible to numerous variations and modifications, and that all of the details mentioned can be substituted for other technically equivalent ones without departing from the scope of protection defined by the attached claims.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed but will include all embodiments falling within the scope thereof

What is claimed is:

1. A lighting device comprising:
a light guide comprising two or more layers; and
a light source that illuminates the light guide, characterized in that the two or more layers define at least one surface between two adjacent layers, geometric motives being formed in the at least one surface.

2. The lighting device according to claim 1, wherein the geometric motives are geometric shapes formed in the at least one surface.

3. The lighting device according to claim 1, wherein the geometric motives are recesses and protrusions made in the at least one surface.

4. The lighting device according to claim 1, wherein the geometric motives have a depth or height from 0.4 to 15 mm.

5. The lighting device according to claim 1, wherein the two or more layers are applied individually by injection.

6. The lighting device according to claim 1, wherein the two or more layers are transparent.

7. The lighting device according to claim 1, wherein the geometric motives are made by engraving, graining or directly during the injection.

8. The lighting device according to claim 1, wherein the light guide is covered by an external lens.

9. The lighting device according to claim 1, wherein the light guide and the light source are housed in a housing.

10. The lighting device according to claim 1, wherein the geometric motives have a texturized surface.

11. The lighting device according to claim 2, wherein the geometric motives are recesses and protrusions made in the at least one surface.

12. The lighting device according to claim 3, wherein the geometric motives have a depth or height from 0.4 to 15 mm.

13. A method of manufacturing a lighting device comprising:
providing a first layer;
forming geometric motives in the first layer;
providing a second layer injected directly to the geometric motives defining a first surface between the first and second layers.

14. The method according to claim 13, further comprising:
forming second geometric motives in the second layer, injecting a third layer directly to the second geometric motives, defining second surface between the third layer and the second layer.

15. The method according to claim 13, wherein the geometric motives are formed by engraving, graining or molding.

16. The method according to claim 13, wherein a surface of the geometric motives is texturized.

17. The method according to claim 14, wherein the geometric motives are formed by engraving, graining or molding.

18. The method according to claim 15, wherein a surface of the geometric motives is texturized.
